(19) United States
(12) Patent Application Publication
(10) Pub. No.: US 2024/0001274 A1
(43) Pub. Date: Jan. 4, 2024

(54) MODULAR RAPPING DUST REMOVER

(71) Applicant: Zhejiang Hongsheng New Material Technology Group Co., Ltd, Zhejiang (CN)

(72) Inventors: Pengze SONG, Zhejiang (CN); Gang LI, Zhejiang (CN)

(73) Assignee: Zhejiang Hongsheng New Material Technology Group Co., Ltd, Zhejiang (CN)

(21) Appl. No.: 18/038,187

(22) PCT Filed: Dec. 24, 2020
(86) PCT No.: PCT/CN2020/138902

§ 371 Date: May 22, 2023

(30) Foreign Application Priority Data
Nov. 23, 2020 (CN) 202011323350.3
Nov. 23, 2020 (CN) 202022728771.6

(51) Int. Cl. B01D 46/04; B01D 46/24; B01D 46/76

(52) U.S. Cl. CPC B01D 46/04; B01D 46/2411; B01D 46/2486; B01D 46/76

(57) ABSTRACT

A modular rapping dust remover, comprising: a dust-air chamber, wherein at least one air inlet is provided in the top of the dust-air chamber, and at least one dust outlet is provided in the bottom of the dust-air chamber; an air intake pipeline, wherein an air output end of the air intake pipeline is in communication with the air inlet of the dust-air chamber; a plurality of filtering members, wherein the plurality of filtering members are arranged inside the dust-air chamber, and a gap is provided between two adjacent filtering members; at least one rapping device arranged in the dust-air chamber, wherein the rapping device can drive the plurality of filtering members to vibrate; at least one air purification chamber; and an air output pipeline, an air intake end of the air output pipeline being in communication with an air outlet of the air purification chamber.

The present disclosure claims the priority to the Chinese patent with the filing No. CN202011323350.3 and entitled “Modular Rapping Dust Remover” and the Chinese patent application with the filing No. CN202022728771.6 and entitled “Modular Rapping Dust Remover” filed on Nov. 23, 2020 with the Chinese Patent Office, the contents of which are incorporated by reference herein in entirety.

### TECHNICAL FIELD

The present disclosure relates to the technical field of dust removal for flue gas, and more particularly, to a modular rapping dust remover.

### BACKGROUND ART

Environmental protection and energy conservation and emission reduction have become focuses of work for the current and future for a long period of time worldwide. The energy-conserving and environmentally-friendly industry has been listed as the top strategic emerging industry in China, and the environmental protection of industries and firms is of top priority. Electric precipitation and bag-type dust removal are leading technologies of industrial environmentally-friendly dust removal at present, and with the trend of increasingly stringent environmental protection policies, the bag-type dust remover has been widely used due to its characteristics such as high filtering efficiency and adaptability to various working conditions, and becomes a mainstream device for industrial flue dust governance at present.

The process principle of the bag-type dust removal is to achieve gas-solid separation by means of physical interception, a core filtering member thereof is a dust filter bag, and meanwhile structural design of the dust remover also will affect overall operation effect. During application of the existing bag-type dust remover, problems such as a large filtration resistance and poor airflow distribution uniformity often occur. In addition, an air inlet direction is inconsistent with a dust settling direction, which is prone to cause flying dusts.

### SUMMARY

In view of this, the present disclosure aims at providing a modular rapping dust remover, and the modular rapping dust remover has a structural design that can effectively reduce flying dusts and realize dust cleaning and regeneration of a filtering member.

In order to achieve the above objective, the present disclosure provides the following technical solution:
a modular rapping dust remover, including:
a dust-air chamber, wherein at least one air inlet is provided at a top of the dust-air chamber, and at least one dust outlet is provided at a bottom of the dust-air chamber;
an air intake pipeline, wherein an air output end of the air intake pipeline is in communication with the air inlet of the dust-air chamber;
a plurality of filtering members, wherein the plurality of filtering members are provided inside the dust-air chamber, and a gap is formed between two adjacent filtering members;
at least one rapping device provided in the dust-air chamber, wherein the rapping device can drive the plurality of filtering members to vibrate;
at least one clean air chamber (air purification chamber), wherein the clean air chamber is provided at one side of the dust-air chamber, and airflow in the dust-air chamber enters the clean air chamber after flowing through the filtering members; and
an air output pipeline, wherein an air intake end of the air output pipeline is in communication with an air outlet of the clean air chamber.

Preferably, the above modular rapping dust remover further includes a pre-charging device, wherein the pre-charging device is arranged upstream of the plurality of filtering members.

Preferably, the above modular rapping dust remover further includes a plurality of guide plates provided in the dust-air chamber, wherein the guide plates are arranged obliquely with respect to a side wall of the dust-air chamber.

Preferably, in the above modular rapping dust remover, the filtering members are filter cartridges; and
the filter cartridges each include a support cylinder, a pleated filter material wrapped on an outer wall of the support cylinder, and a first cover and a second cover fixedly connected to two ends of the support cylinder respectively, a plurality of through-holes are formed on a cylinder wall of the support cylinder and at least one end of the support cylinder forms an air outlet, and the airflow, after entering the support cylinder through the pleated filter material, is discharged through the air outlet formed by the at least one end of the support cylinder.

Preferably, in the above modular rapping dust remover, the air intake pipeline includes an air intake pipe and an air intake box connected in sequence, the air intake box is connected to an air output end of the air intake pipe; and the air output pipeline includes an air output pipe and an air output box connected in sequence, the air output box is connected to an air intake end of the air output pipe; and
the air intake box and the air output box are both horn-shaped, and a ventilation section of the air intake box is gradually increased in size in a direction towards the dust-air chamber, and a ventilation section of the air output box is gradually increased in size in a direction towards the clean air chamber.

Preferably, in the above modular rapping dust remover, the air output box is connected to the top of the clean air chamber.

Preferably, in the above modular rapping dust remover, the number of the clean air chambers is two, and the two clean air chambers are respectively provided at two opposite sides of the dust-air chamber.

Preferably, the above modular rapping dust remover further includes a metal frame arranged inside the dust-air chamber, and the metal frame is provided therein with at least one of the filtering members fixedly connected thereto; and
further includes a rapping device, wherein the rapping device is configured to rap the metal frame so as to make the metal frame and the filtering member vibrate.

Preferably, the above modular rapping dust remover further includes a dust hopper in communication with the dust outlet of the dust-air chamber and a dust conveying device connected to a bottom of the dust hopper.

Preferably, in the above modular rapping dust remover, both the dust-air chamber and the clean air chamber are integrated in the same box body, and the dust-air chamber is separated from the clean air chamber by a partition plate.

When the modular rapping dust remover provided in the above is applied, the dust-containing airflow enters the dust-air chamber through the air intake pipeline and the air inlet at the top of the dust-air chamber, air in the dust-air chamber enters the plurality of filtering members for filtration, the airflow filtered by the plurality of filtering members enters the clean air chamber, and finally air in the clean air chamber can be discharged through the air output pipeline. In the above filtering process, the dust-containing airflow enters the dust-air chamber through the air inlet at the top of the dust-air chamber, such that an inlet airflow direction is consistent with a falling direction of the dusts, and the dusts can descend to the dust outlet at the bottom of the dust-air chamber, which is more beneficial to settling of the dusts, and effectively reduces flying dusts. In addition, when a lot of dusts are accumulated on outer surfaces of the filtering members and a filtering resistance is relatively large, the rapping device can be turned on, the rapping device drives the plurality of filtering members to vibrate, and after the dusts on the surfaces of the filtering members are shaken, the dusts accumulated on the surfaces fall off, thus realizing dust cleaning and regeneration.

### BRIEF DESCRIPTION OF DRAWINGS

In order to illustrate the technical solutions in the embodiments of the present disclosure or in the prior art more clearly, drawings that need to be used in the description of the embodiments or the prior art are introduced briefly below, obviously, the drawings in the following description are only for some embodiments of the present disclosure, and those ordinarily skilled in the art still could obtain other drawings in light of these drawings, without using any creative efforts.

FIG. 1 is a structural schematic diagram of integrated denitration and dust removal equipment provided in an embodiment of the present disclosure; and

FIG. 2 is a schematic diagram of three-layer integrated denitration and dust removal equipment provided in an embodiment of the present disclosure.

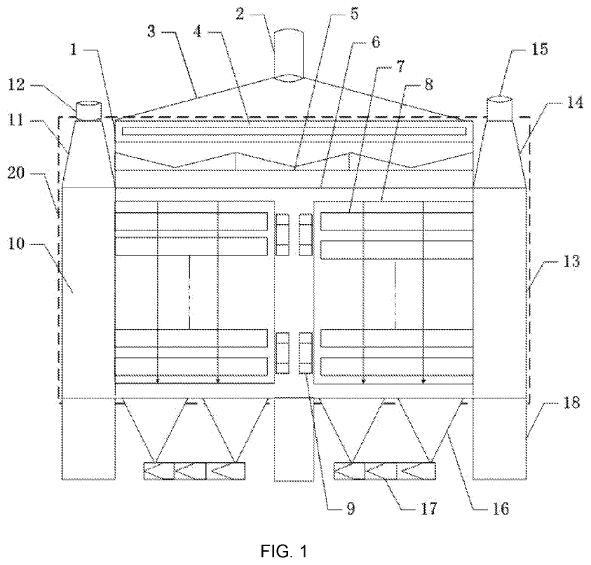

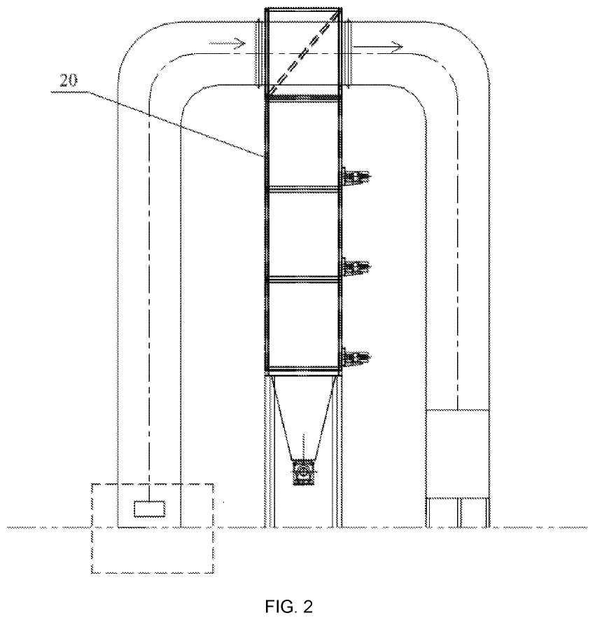

In FIGS. 1-2:
1—rapping dust remover, 2—air intake pipe, 3—air intake box, 4—pre-charging device, 5—guide plate, 6—dust-air chamber, 7—filtering member, 8—metal frame, 9—rapping device, 10—left clean air chamber, 11—left air output box, 12—left air output pipe, 13—right clean air chamber, 14—right air output box, 15—right air output pipe, 16—dust hopper, 17—dust conveying device, 18—steel stud, 19—denitration catalyst module, 20—single modular rapping dust remover.

### DETAILED DESCRIPTION OF EMBODIMENTS

The present disclosure aims at providing a modular rapping dust remover, which has a structural design that can effectively reduce flying dusts and realize dust cleaning and regeneration of a filtering member.

The technical solutions in the embodiments of the present disclosure will be clearly and completely described below in combination with the drawings in the embodiments of the present disclosure, and obviously, the embodiments described are only part of the embodiments of the present disclosure, rather than all embodiments. All of other embodiments, obtained by a person ordinarily skilled in the art based on the embodiments in the present disclosure without using any creative efforts, shall fall into the scope of protection of the present disclosure.

In the description of the present disclosure, it should be understood that orientation or positional relationships indicated by terms, such as “upper”, “lower”, “front”, “back”, “left”, and “right” are based on orientation or positional relationships as shown in the drawings, merely for facilitating the description of the present disclosure and simplifying the description, rather than indicating or implying that related devices or elements have to be in the specific orientation or configured and operated in a specific orientation, therefore, they should not be construed as limitation to the present disclosure. Besides, terms such as “first” and “second” are merely used for descriptive purpose, but cannot to be construed as indicating or implying importance in the relativity.

Please refer to FIG. 1 and FIG. 2, an integrated denitration and dust removal equipment provided in the present disclosure includes a dust-air chamber 6, an air intake pipeline, a plurality of filtering members 7, a rapping device 9, at least one clean air chamber, and an air output pipeline.

In the above, at least one air inlet is provided at a top of the dust-air chamber 6. That is, the top of the dust-air chamber 6 can be opened to form an air inlet, and a ventilation section of the air inlet covers the entire top of the dust-air chamber 6. Alternatively, a plurality of air inlets can be provided at the top of the dust-air chamber 6. Dust-containing airflow enters the dust-air chamber 6 through the air inlet at the top of the dust-air chamber 6. At least one dust outlet is provided at a bottom of the dust-air chamber 6, and dusts are discharged through the dust outlet at the bottom of the dust-air chamber 6.

An air output end of the air intake pipeline is in communication with the air inlet of the dust-air chamber 6, and the dust-containing airflow in the air intake pipeline enters the dust-air chamber 6 through the air output end of the air intake pipeline.

The plurality of filtering members 7 are provided inside the dust-air chamber 6, a gap is formed between two adjacent filtering members 7. That is, the plurality of filtering members 7 are all fixed in the dust-air chamber 6, and at least one end of each filtering member 7 is connected to a side wall of the dust-air chamber 6. Preferably, the dust-air chamber 6 is in a cuboid shape, and the plurality of filtering members 7 are arranged parallel to each other in a lengthwise direction. An axial direction of the filtering members 7 can be horizontally provided, or an angle between the axial direction of the filtering members 7 and a horizontal plane is an acute angle, which is not limited herein.

The number of rapping devices 9 is one or more, and the rapping device 9 is provided in the dust-air chamber 6. The rapping device 9 can drive the plurality of filtering members 7 to vibrate. When the rapping device 9 is turned on, the rapping device 9 drives the plurality of filtering members 7 to vibrate, and after dusts on surfaces of the filtering members 7 are shaken, the dusts accumulated on the surfaces fall off, thus realizing dust cleaning and regeneration.

The number of clean air chambers is one or more. The clean air chamber is provided at one side of the dust-air chamber 6, and the airflow in the dust-air chamber 6 enters the clean air chamber after flowing through the filtering members 7.

An air intake end of the air output pipeline is in communication with an air outlet of the clean air chamber, that is, air that enters the clean air chamber after being filtered can be discharged through the air output pipeline.

When the modular rapping dust remover provided in the above is applied, the dust-containing airflow enters the dust-air chamber 6 through the air intake pipeline and the air inlet at the top of the dust-air chamber 6, air in the dust-air chamber 6 enters the plurality of filtering members 7 for filtration, the airflow filtered by the plurality of filtering members 7 enters the clean air chamber, and finally air in the clean air chamber can be discharged through the air output pipeline. In the above filtering process, the dust-containing airflow enters the dust-air chamber 6 through the air inlet at the top of the dust-air chamber 6, such that an inlet airflow direction is consistent with a falling direction of the dusts, and the dusts can descend to the dust outlet at the bottom of the dust-air chamber 6, which is more beneficial to settling of the dusts, and effectively reduces flying dusts. In addition, when a lot of dusts are accumulated on outer surfaces of the filtering members and a filtering resistance is relatively large, the rapping device 9 can be turned on, the rapping device 9 drives the plurality of filtering members 7 to vibrate, and after the dusts on the surfaces of the filtering members 7 are shaken, the dusts accumulated on the surfaces fall off, thus realizing dust cleaning and regeneration.

The dust-air chamber 6, the clean air chamber, and devices therein together form a rapping dust remover 1.

In a specific embodiment, the above modular rapping dust remover can further include a pre-charging device 4, and the pre-charging device 4 is arranged upstream of the filtering members 7. That is, the pre-charging device 4 is located upstream of the plurality of filtering members 7, and the dust-containing airflow that enters the dust-air chamber 6 through the air inlet at the top of the dust-air chamber 6 first passes through the pre-charging device 4 and then passes through the filtering members 7. Specifically, the pre-charging device 4 can be provided in the dust-air chamber 6, and the pre-charging device 4 is disposed between the air inlet of the dust-air chamber 6 and the filtering members 7. By providing the pre-charging device 4 below the air inlet of the dust-air chamber 6, the dusts can be charged, the charged fine dusts can congeal into relatively large particles, where a part of the particles directly fall out from the dust outlet along with the airflow, and a part of the particles form a loose-structured dust layer on the surfaces of the filtering members 7, and meanwhile, charging of the dusts facilitates trapping, so that a dust concentration at an entrance of the dust-air chamber 6 can be greatly improved. Test data show that the integrated denitration and dust removal equipment provided with the pre-charging device 4 can improve the filtering efficiency by one order of magnitude, and the filtering resistance is obviously reduced, which facilitates improving the filtering speed and prolonging the service lifetime of the filtering members 7.

The pre-charging device 4 is fixed inside the dust-air chamber 6, and it can be fixed relative to the dust-air chamber 6 by means of bolting, clamping, etc.

In another specific embodiment, the above modular rapping dust remover further includes a plurality of guide plates 5 provided in the dust-air chamber 6, and the plurality of guide plates 5 are arranged obliquely with respect to the side wall of the dust-air chamber 6. That is, the guide plates 5 have an included angle with both the side wall and a bottom wall of the dust-air chamber 6. The plurality of guide plates 5 are fixed in the dust-air chamber 6, and a gap is formed between two adjacent guide plates 5 for airflow to pass through. With such configuration, dust-containing smoke enters the dust-air chamber 6 under the guidance of the guide plates 5, and the dust-containing smoke changes a flowing direction after passing through the guide plates 5, in this way, not only defects that the dusts directly brush the filtering members 7 and easily wear the filtering members 7 can be overcome, but also distribution of the airflow inside the dust-air chamber 6 can be more uniform, avoiding existence of an inlet dead space.

The guide plates 5 are fixed inside the dust-air chamber 6, and specifically, the guide plates 5 can be bolted, clamped, or welded in the dust-air chamber 6, which is not limited herein.

Preferably, the plurality of guide plates 5 can be arranged along a continuous bending line, or the included angle between the guide plates 5 and the side wall of the dust-air chamber 6 is not limited, and a shape, an inclined angle, and positions of the plurality of guide plates 5 can be arranged according to actual situations.

Preferably, the above filtering members 7 are filter cartridges. Definitely, the filtering members 7 also may be filter bags, which is not limited herein.

Each filter cartridge includes a support cylinder, a pleated filter material, a first cover, and a second cover. In the above, the pleated filter material is wrapped on an outer wall of the support cylinder. The first cover and the second cover are fixedly connected to two ends of the support cylinder respectively, and the first cover and the second cover can be bolted or clamped with the support cylinder, thus facilitating subsequent maintenance and inspection.

A plurality of through-holes are formed on a cylinder wall of the support cylinder, so that the airflow passing through the pleated filter material enters the support cylinder through the through-holes on the support cylinder. One end or two ends of the support cylinder form an air outlet, in other words, one end or two ends of the support cylinder form an air outlet of the filter cartridge.

When the filter cartridge performs filtration, the dust-containing airflow enters the support cylinder after passing through the pleated filter material, and air in the support cylinder is discharged through the air outlet of the support cylinder.

The filter cartridge is preferably a high-temperature-resistant filter cartridge, a preparation method of the filter cartridge is as follows: firstly, a filter material is processed into a pleated structure, and the high-temperature-resistant filter material is folded according to process requirements by means of a folding machine. One end of the pleated high-temperature-resistant filter material that is folded is connected to the first cover, and the other end is connected to the second cover, thus forming the high-temperature-resistant filter cartridge. The support cylinder is made of a metal material, so as to ensure that the pleated filter material will not be deformed during blowing dust cleaning.

The pleated filter material may be a stiff glass fiber filter material, a stiff glass fiber-coated filter material, a stiff perlite swelling felt material, a stiff glass fiber-blended filter material, a stiff high silicone (modified) fiber-coated filter material, and the like.

It should be noted herein that, a through-hole in communication with the clean air chamber is provided on the side wall of the dust-air chamber 6, the air outlet of the support cylinder is in communication with the through-hole on the side wall of the dust-air chamber 6, and the air outlet of the support cylinder is connected to the side wall of the dust-air chamber 6 in a sealed manner, so as to ensure that, in a normal process, air in the dust-air chamber 6 can only enter the support cylinder through the pleated filter material, and air inside the support cylinder can only flow into the clean air chamber.

Preferably, the air intake pipeline includes an air intake pipe 2 and an air intake box 3 connected in sequence, the air intake box 3 is connected to an air output end of the air intake pipe 2, and the dust-containing airflow enters the dust-air chamber 6 after passing through the air intake pipe 2 and the air intake box 3 in sequence. The air intake box 3 may be horn-shaped, and a ventilation section of the air intake box 3 is gradually increased in size in a direction approaching the dust-air chamber 6. That is, the ventilation section of the air output end of the air intake box 3 is larger than a ventilation section of the air intake end. Such configuration can further ensure more uniform airflow entering the dust-air chamber 6.

The air output pipeline includes an air output pipe and an air output box connected in sequence, the air output box is connected to an air intake end of the air output pipe, and the airflow is discharged after passing through the air output box and the air output pipe in sequence. The air intake box may be horn-shaped, and a ventilation section of the air intake box is gradually increased in size in a direction approaching the clean air chamber. Such configuration can further ensure more uniform outlet airflow.

Further, the air output box 3 can be connected to the top of the clean air chamber, so as to facilitate the direct entry of the smoke into a chimney. Definitely, the air output box 3 may also be connected to a bottom or a side wall of the clean air chamber, which is not limited herein.

Preferably, the number of clean air chambers is two, and the two clean air chambers are respectively provided at two opposite sides of the dust-air chamber 6. The two clean air chambers are a left clean air chamber 10 and a right clean air chamber 13 respectively. Both the left clean air chamber 10 and the right clean air chamber 13 are in communication with the air outlets of the filtering members 7 in the dust-air chamber 6. The number of air output pipelines is also two and they are a left air output pipe 12 and a right air output pipe 15 respectively. The number of air output boxes is also two and they are a left air output box 11 and a right air output box 14 respectively. The left air output box 11 and the left air output pipe 12 are in communication with the interior of the left clean air chamber 10, and the right air output box 14 and the right air output pipe 15 are in communication with the interior of the right clean air chamber 13.

The left air output box 11 can be connected to a top wall of the left clean air chamber 10, and the right air output box 14 can be connected to a top wall of the right clean air chamber 13, which are not limited herein.

Further, the above modular rapping dust remover also includes a metal frame 8 arranged inside the dust-air chamber 6, and the metal frame 8 is provided therein with at least one filtering member 7 fixedly connected thereto. The filtering member 7 located inside the metal frame 8 is fixedly connected to the metal frame 8. The metal frame 8 is integrated with the filtering member 7 therein. One side of the metal frame 8 can be fixedly connected to the inner wall of the dust-air chamber 6. Preferably, a rapping device 9 is further included, and the rapping device 9 is configured to rap the metal frame 8 so as to make the metal frame 8 and the filtering member 7 vibrate. When the rapping device 9 is turned on, after dusts on the surface of the filtering member 7 is shaken, the dusts accumulated on the surface fall off, thus realizing dust cleaning and regeneration. A dust-cleaning mode is configured to be rapping dust cleaning, and the metal frame and the filtering member 7 are shaken through the rapping, so as to shake out the dusts accumulated on the surface.

Specifically, the number of metal frames 8 is two, and the two metal frames 8 are a left metal frame and a right metal frame respectively, the left metal frame and the right metal frame are fixedly connected to a left side wall and a right side wall of the dust-air chamber 6 respectively, the air outlet of the filtering member 7 in the left metal frame is in communication with the left clean air chamber 10, and the air outlet of the filtering member 7 in the right metal frame is in communication with the right clean air chamber 13. A left end of the filtering member 7 in the left metal frame is connected to the left side wall of the dust-air chamber 6, and a right end of the filtering member 7 in the left metal frame is closed or covered by the filter material. A right end of the filtering member 7 in the right metal frame is connected to the right side wall of the dust-air chamber 6, and a left end of the filtering member 7 in the left metal frame is closed or covered by the filter material.

In order to timely collect the dusts falling to the dust outlet, the above modular rapping dust remover further includes a dust hopper 16, which is in communication with the dust outlet of the dust-air chamber 6 and a dust conveying device 17 connected to a bottom of the dust hopper 16. A top opening of the dust hopper 16 is connected to the dust outlet, in this way, the dusts fall to the dust outlet, then enter the dust hopper 16, and are finally transferred by the dust conveying device 17.

In the above embodiments, the dust conveying device 17 may be a screw rod device, a pneumatic device, or the like, which is not limited herein.

In a preferred embodiment, both the dust-air chamber 6 and the clean air chamber are integrated in the same box body, and the dust-air chamber 6 is separated from the clean air chamber by a partition plate. In this way, all of the filtering members 7, the pre-charging device 4, the guide plates 5, the rapping device 9, and a blowing device can be integrated in the box body, which is more convenient for modular manufacturing and processing. Herein, all parts are substantially processed in a factory, and are transported to a site for assembly to make the modular rapping dust remover, which reduces the construction cycle by ⅔ or more compared with ordinary dust removers. Steel studs 18 can be provided below the box body so as to support the box body.

During specific application, a single modular rapping dust remover 20 can be used according to the working condition and the filtering area, and a plurality of modular rapping dust removers can also be in stacked connection and used together in combination, thus saving an occupation space and improving production efficiency. FIG. 2 is a schematic diagram of stacked connection and combination of three modular rapping dust removers.

In the following, a more specific embodiment is provided, in which the modular rapping dust remover includes the dust-air chamber 6, the air intake pipeline, the air intake box 3, the pre-charging device 4, the guide plates 5, a plurality of filtering members 7, the left clean air chamber 10, the left metal frame, the left air output box 11, the left air output pipe 12, the right metal frame, the right blowing device, the right air output box 14, the right air output pipe 15, the rapping device 9, the dust hopper 16, and the dust conveying device 17. In the above, the pre-charging device 4 and the guide plates 5 are located in the dust-air chamber 6, and the pre-charging device 4 is located above the guide plates 5. The left metal frame and the right metal frame are distributed to the left and right in the dust-air chamber 6, a plurality of filtering members 7 are provided in both the left metal frame and the right metal frame, and the left clean air chamber 10 is in communication with the air outlets of the filtering members 7 in the left metal frame. The right clean air chamber 13 is in communication with the air outlets of the filtering members 7 in the right metal frame. The rapping device 9 is located in the dust-air chamber 6.

When the modular rapping dust remover in the above embodiment performs treatment on the smoke, the dust-containing airflow enters the dust-air chamber 6 through the air intake pipeline and the air intake box 3 in sequence, and enters the dust-air chamber 6 through the pre-charging device 4 and the guide plates 5 in sequence in the dust-air chamber 6. Under the action of the pre-charging device 4, a part of fine dusts congeal into large dusts, after passing through the guide plates 5, the airflow direction is changed, and a part of large dusts accelerate and fall into the dust hopper 16 under the action of inertia. A part of the airflow entering the dust-air chamber 6 is filtered by the filtering member 7 in the left metal frame and then enters the left clean air chamber 10, and the other part of the airflow is filtered by the filtering member 7 in the right metal frame and then enters the right clean air chamber 13. That is, the dust-containing airflow enters the interior through the surfaces of the filtering members 7, the dusts are trapped on the surfaces, and clean air enters the clean air chambers on two sides through the air outlets of the filtering members 7. It can be seen therefrom that the modular rapping dust remover adopts a manner of upper air inlet and side air outlet, where the dust-containing airflow enters the dust-air chamber 6 from an upper portion of the dust-air chamber 6, is filtered and purified by the filtering members 7, and then is discharged through both the left and right clean air chambers of the dust-air chamber 6 and an air outlet system. The inlet airflow direction is consistent with the dust falling direction, which facilitates quick downward settling of the dusts.

The left metal frame and the right metal frame are each provided with the rapping device 9. The dust-containing airflow enters the clean air chamber after being filtered and purified by the filtering members 7, after the dusts are trapped on surfaces of filter bags to reach a certain pressure value, the rapping device 9 is turned on to rap and clean the dusts, and the dusts accumulated on the surfaces of the filtering members 7 fall into the dust hopper 16 after being shaken, and are output from the dust remover through the dust conveying device 17. After the dust cleaning, the filtering members 7 are regenerated, and restore low-resistance operation. The air filtered and purified by the filtering members 7 enters the left and right clean air chambers respectively, thus realizing the dust treatment. The purified air is discharged from the dust remover via the air outlet and the air output pipeline, and air outlet volumes on the two sides can be controlled as required. During installation and maintenance, the clean air chambers at the two sides can be opened to facilitate installation and maintenance of the filtering members 7.

Various embodiments in the present description are described in a progressive manner, each embodiment is focused on the differences from other embodiments, and the same or similar parts between various embodiments may refer to each other.

According to the above description of the embodiments disclosed, those professionally skilled in the art could implement or use the present disclosure. Various modifications to these embodiments are apparent to those professionally skilled in the art, and general principles defined herein can be implemented in other embodiments without departing from the spirit or scope of the present disclosure. Therefore, the present disclosure will not be limited to these embodiments shown herein, but should conform to the broadest scope consistent to the principle and novel features disclosed herein.

1. A modular rapping dust remover, comprising:
a dust-air chamber, wherein at least one air inlet is provided at a top of the dust-air chamber, and at least one dust outlet is provided at a bottom of the dust-air chamber;
an air intake pipeline, wherein an air output end of the air intake pipeline is in communication with the air inlet of the dust-air chamber;
a plurality of filtering members, wherein the plurality of filtering members are provided inside the dust-air chamber, and a gap is formed between two adjacent filtering members;
at least one rapping device, provided in the dust-air chamber, wherein the rapping device can drive a plurality of the filtering members to vibrate;
at least one clean air chamber, wherein the clean air chamber is provided at one side of the dust-air chamber, and airflow in the dust-air chamber enters the clean air chamber after flowing through the filtering members; and
an air output pipeline, wherein an air intake end of the air output pipeline is in communication with an air outlet of the clean air chamber.

2. The modular rapping dust remover according to claim 1, further comprising a pre-charging device, wherein the pre-charging device is arranged upstream of a plurality of the filtering members.

3. The modular rapping dust remover according to claim 1, further comprising a plurality of guide plates provided in the dust-air chamber, wherein the guide plates are arranged obliquely with respect to a side wall of the dust-air chamber.

4. The modular rapping dust remover according to claim 1, wherein the filtering members are filter cartridges; and the filter cartridges each comprise a support cylinder, a pleated filter material wrapped on an outer wall of the support cylinder, and a first cover and a second cover fixedly connected to two ends of the support cylinder respectively, wherein a plurality of through-holes are formed on a cylinder wall of the support cylinder and at least one end of the support cylinder forms an air outlet, and the airflow, after entering the support cylinder through the pleated filter material, is discharged through the air outlet formed by the at least one end of the support cylinder.

5. The modular rapping dust remover according to claim 1, wherein the air intake pipeline comprises an air intake pipe and an air intake box connected in sequence, the air intake box is connected to an air output end of the air intake pipe, and wherein the air output pipeline comprises an air output pipe and an air output box connected in sequence, the air output box is connected to an air intake end of the air output pipe; and
the air intake box and the air output box are both horn-shaped, and a ventilation section of the air intake box is gradually increased in size in a direction towards the dust-air chamber, and a ventilation section of the air output box is gradually increased in size in a direction towards the clean air chamber.

6. The modular rapping dust remover according to claim 5, wherein the air output box is connected to the top of the clean air chamber.

7. The modular rapping dust remover according to claim 1, wherein the clean air chambers is in number of two, and the two clean air chambers are respectively provided at two opposite sides of the dust-air chamber.

8. The modular rapping dust remover according to claim 1, further comprising a metal frame arranged inside the dust-air chamber, and the metal frame is provided therein with at least one filtering members fixedly connected thereto; and
further comprising a rapping device, wherein the rapping device is configured to rap the metal frame so as to make the metal frame and the filtering member vibrate.

9. The modular rapping dust remover according to claim 1, further comprising a dust hopper in communication with the dust outlet of the dust-air chamber and a dust conveying device connected to a bottom of the dust hopper.

10. The modular rapping dust remover according to claim 1, wherein both the dust-air chamber and the clean air chamber are integrated in the same box body, and the dust-air chamber is separated from the clean air chamber by a partition plate.

11. The modular rapping dust remover according to claim 2, wherein both the dust-air chamber and the clean air chamber are integrated in the same box body, and the dust-air chamber is separated from the clean air chamber by a partition plate.

12. The modular rapping dust remover according to claim 3, wherein both the dust-air chamber and the clean air chamber are integrated in the same box body, and the dust-air chamber is separated from the clean air chamber by a partition plate.

13. The modular rapping dust remover according to claim 4, wherein both the dust-air chamber and the clean air chamber are integrated in the same box body, and the dust-air chamber is separated from the clean air chamber by a partition plate.

14. The modular rapping dust remover according to claim 5, wherein both the dust-air chamber and the clean air chamber are integrated in the same box body, and the dust-air chamber is separated from the clean air chamber by a partition plate.

15. The modular rapping dust remover according to claim 6, wherein both the dust-air chamber and the clean air chamber are integrated in the same box body, and the dust-air chamber is separated from the clean air chamber by a partition plate.

16. The modular rapping dust remover according to claim 7, wherein both the dust-air chamber and the clean air chamber are integrated in the same box body, and the dust-air chamber is separated from the clean air chamber by a partition plate.

17. The modular rapping dust remover according to claim 8, wherein both the dust-air chamber and the clean air chamber are integrated in the same box body, and the dust-air chamber is separated from the clean air chamber by a partition plate.

18. The modular rapping dust remover according to claim 9, wherein both the dust-air chamber and the clean air chamber are integrated in the same box body, and the dust-air chamber is separated from the clean air chamber by a partition plate.
